(19) United States
(12) Patent Application Publication
(10) Pub. No.: US 2019/0310651 A1
(43) Pub. Date: Oct. 10, 2019

(54) Object Detection and Determination of Motion Information Using Curve-Fitting in Autonomous Vehicle Applications

(71) Applicant: Uber Technologies, Inc., San Francisco, CA (US)

(72) Inventors: Carlos Vallespi-Gonzalez, Pittsburgh, PA (US); Siheng Chen, Pittsburgh, PA (US); Abhishek Sen, Pittsburgh, PA (US); Ankit Laddha, Pittsburgh, PA (US)

(21) Appl. No.: 16/020,193

(22) Filed: Jun. 27, 2018

Related U.S. Application Data
(60) Provisional application No. 62/655,432, filed on Apr. 10, 2018.

(51) Int. Cl. G05D 1/02; G05D 1/00; G01S 17/93; G01S 17/58; G01S 7/48

(52) U.S. Cl. CPC G05D 1/0231; G05D 1/0221; G05D 1/0088; G05D 2201/0213; G01S 17/58; G01S 7/4808; G01S 17/936

(57) ABSTRACT

Generally, the present disclosure is directed to systems and methods for detecting objects of interest and determining location information and motion information for the detected objects based at least in part on sensor data (e.g., LIDAR data) provided from one or more sensor systems (e.g., LIDAR systems) included in the autonomous vehicle. The perception system can include a machine-learned detector model that is configured to receive multiple time frames of sensor data and implement curve-fitting of sensor data points over the multiple time frames of sensor data. The machine-learned model can be trained to determine, in response to the multiple time frames of sensor data provided as input, location information descriptive of a location of one or more objects of interest detected within the environment at a given time and motion information descriptive of the motion of each object of interest.

### PRIORITY CLAIM

This application claims priority to U.S. Patent Application Ser. No. 62/655,432, filed Apr. 10, 2018, and entitled “OBJECT DETECTION AND DETERMINATION OF MOTION INFORMATION USING CURVE-FITTING IN AUTONOMOUS VEHICLE APPLICATIONS,” the disclosure of which is incorporated by reference herein in its entirety.

### FIELD

The present disclosure relates generally to autonomous vehicles. More particularly, the present disclosure relates to systems and methods for detecting objects and determining location information and motion information within one or more systems of an autonomous vehicle.

### BACKGROUND

An autonomous vehicle is a vehicle that is capable of sensing its environment and navigating with little to no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path through such surrounding environment.

Thus, a key objective associated with an autonomous vehicle is the ability to perceive objects (e.g., vehicles, pedestrians, cyclists) that are proximate to the autonomous vehicle and, further, to determine classifications of such objects as well as their locations. The ability to accurately and precisely detect and characterize objects of interest is fundamental to enabling the autonomous vehicle to generate an appropriate motion plan through its surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes receiving, by a computing system comprising one or more computing devices, multiple time frames of sensor data descriptive of an environment surrounding an autonomous vehicle. The method also includes inputting, by the computing system, the multiple time frames of sensor data to a machine-learned detector model that is configured to implement curve-fitting of sensor data points over the multiple time frames of sensor data. The method also includes receiving, by the computing system as an output of the machine-learned detector model, location information descriptive of a location of each object of interest detected within the environment at a given time and motion information descriptive of the motion of each object of interest. The method also includes determining, by the computing system and based on the location information and the motion information for each object of interest, a predicted track for each object of interest over time relative to the autonomous vehicle.

Another example aspect of the present disclosure is directed to a computing system. The computing system includes a light detection and ranging (LIDAR) system configured to gather successive time frames of LIDAR data descriptive of an environment surrounding an autonomous vehicle. The computing system also includes one or more processors. The computing system also includes a machine-learned detector model that has been trained to analyze multiple time frames of LIDAR data to detect objects of interest and to implement curve-fitting of LIDAR data points over the multiple time frames to determine one or more motion parameters descriptive of the motion of each detected object of interest. The computing system also includes at least one tangible, non-transitory computer readable medium that stores instructions that, when executed by the one or more processors, cause the one or more processors to perform operations. The operations include providing multiple time frames of LIDAR data to the machine-learned detector model. The operations also include receiving as an output of the machine-learned detector model, location information descriptive of a location of each object of interest detected within the environment at a given time and motion information descriptive of the motion of each object of interest.

Another example aspect of the present disclosure is directed to an autonomous vehicle. The autonomous vehicle includes a sensor system comprising at least one sensor configured to generate multiple time frames of sensor data descriptive of an environment surrounding an autonomous vehicle. The autonomous vehicle also includes a vehicle computing system comprising one or more processors and at least one tangible, non-transitory computer readable medium that stores instructions that, when executed by the one or more processors, cause the one or more processors to perform operations. The operations include inputting the multiple time frames of sensor data to a machine-learned detector model that is configured to implement curve-fitting of sensor data points over the multiple time frames of sensor data. The operations also include receiving, as an output of the machine-learned detector model, location information descriptive of a location of each object of interest detected within the environment at a given time and motion information descriptive of the motion of each object of interest. The operations also include determining a motion plan for the autonomous vehicle that navigates the autonomous vehicle relative to each object of interest, wherein the motion plan is determined based at least in part from the location information and the motion information for each object of interest.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example autonomy system for an autonomous vehicle according to example embodiments of the present disclosure;

FIG. 2 depicts an example perception system according to example embodiments of the present disclosure;

FIG. 3 depicts an example range-view representation of LIDAR data according to example embodiments of the present disclosure;

FIG. 4 depicts an example top-view representation of LIDAR data according to example embodiments of the present disclosure;

FIG. 5 depicts an example top-view representation of LIDAR data discretized into cells according to example embodiments of the present disclosure;

FIG. 6 depicts an example object detection system according to example embodiments of the present disclosure;

FIG. 7 depicts an example representation of a first aspect of sensor data according to example embodiments of the present disclosure;

FIG. 8 depicts an example representation of a second aspect of sensor data according to example embodiments of the present disclosure;

FIG. 9 depicts an example representation of a first aspect of curve fitting to sensor data according to example embodiments of the present disclosure;

FIG. 10 depicts an example representation of a second aspect of curve fitting to sensor data according to example embodiments of the present disclosure;

FIG. 11 depicts a flow chart diagram of an example method according to example aspects of the present disclosure; and

FIG. 12 depicts a block diagram of an example computing system according to example embodiments of the present disclosure.

### DETAILED DESCRIPTION

Generally, the present disclosure is directed to detecting, classifying, and tracking objects, such as pedestrians, cyclists, other vehicles (whether stationary or moving), and the like, during the operation of an autonomous vehicle. In particular, in some embodiments of the present disclosure, an autonomous vehicle can include a perception system that detects object of interest and determines location information and motion information for the detected objects based at least in part on sensor data (e.g., LIDAR data) provided from one or more sensor systems (e.g., LIDAR systems) included in the autonomous vehicle. The perception system can include a machine-learned detector model that is configured to receive multiple time frames of sensor data. The machine-learned model can be trained to determine, in response to the multiple time frames of sensor data provided as input, location information descriptive of a location of one or more objects of interest detected within the environment at a given time and motion information descriptive of the motion of each object of interest. Because of the comprehensive nature of providing multiple time frames of sensor data input and the ability to include motion information for detected objects, the accuracy of object detection and associated object prediction can be improved. As a result, further analysis in autonomous vehicle applications is enhanced, such as those involving prediction, motion planning, and vehicle control, leading to improved passenger safety and vehicle efficiency.

More particularly, in some implementations, an autonomous vehicle (e.g., its vehicle computing system) can include an object detection system. The object detection system can include, for example, a machine-learned detector model. The machine-learned detector model can have been trained to analyze multiple successive time frames of LIDAR data to detect objects of interest and to generate motion information descriptive of the motion of each object of interest. The vehicle computing system can also include one or more processors and at least one tangible, non-transitory computer readable medium that stores instructions that, when executed by the one or more processors, cause the one or more processors to perform operations. The operations can include providing multiple time frames of sensor data to the machine-learned detector model and receiving, as an output of the machine-learned detector model, location information descriptive of a location of one or more objects of interest (or sensor data points) detected within the environment at a given time as well as motion information descriptive of the motion of each detected object of interest (or sensor data point).

In some implementations, the multiple time frames of sensor data include a buffer of N sensor data samples captured at different time intervals. In some implementations, the sensor data samples are captured over a range of time (e.g., 0.5 seconds, 1 second, etc.). In some implementations, the sensor data samples are captured at successive time frames that are spaced at equal intervals from one another. For example, in one implementation, the multiple time frames of sensor data can include N sensor data samples captured at times t, t−0.1, t−0.2, . . . , t−(N−1)*0.1) seconds. The multiple time frames of data can be provided as input to a machine-learned detector model. In some implementations, a buffer including multiple time frames of sensor data can be provided as input to a machine-learned detector model, such that the multiple time frames of sensor data are simultaneously provided as input to the machine-learned detector model.

In some implementations, the motion information descriptive of the motion of each object of interest can include one or more parameters (e.g., velocity, acceleration, etc.) descriptive of the motion of each detected object of interest. To determine such motion parameters, the machine-learned detector model can be configured to implement curve-fitting relative to each detected object of interest over the multiple time frames of sensor data to determine the parameters.

Any of a variety of curve-fitting procedures can be employed, although one particular example involves a polynomial fitting of a location of each detected object of interest over multiple time frames to a polynomial having a plurality of coefficients. In some implementations, the one or more parameters included in the motion information can be determined, based on the curve-fitting, from the plurality of coefficients of the polynomial. For instance, a polynomial p(t) of the second order (e.g., p(t)=a+bt+ct²) can be employed in the curve-fitting, where the first term (a) is a bias term describing the location of a detected object, the second term (bt) includes a coefficient “b” representing the velocity of the detected object, and the third term (ct²) includes a coefficient “c” representing the acceleration of the detected object. There can also be higher order terms in the curve-fitting polynomial.

In some implementations, the motion information descriptive of the motion of each object of interest can include a location of each object of interest at one or more subsequent times after the given time. In such instances, differences between the location of the object of interest at the given time and the one or more subsequent times can be used to determine the parameters of the motion information, such as velocity, acceleration and the like.

In some implementations, the machine-learned detector model is further configured to generate a classification label associated with each detected object of interest. The classification label can include an indication of whether an object of interest is determined to correspond to a particular type of object of interest from a predetermined set of objects of interest (e.g., a vehicle, a bicycle, a pedestrian, etc.). In some examples, the classification for each object of interest can also include a confidence score associated with each classification indicating the probability that such classification is correct. When the machine-learned detector model is trained to provide outputs for each data point of sensor data (as opposed to for detected objects of interest), the classification label and/or confidence scores can be determined by the model for each data point.

In some implementations, the machine-learned detector model is further configured to fit bounding shapes (e.g., two-dimensional or three-dimensional bounding boxes and/or bounding polygons) to detected objects of interest. In some implementations, the bounding shapes can be generated within the representation of sensor data (e.g., LIDAR data) having a greater number of total data points (e.g., cells). By processing a more comprehensive representation of sensor data from a top-view representation for the determination of bounding shapes, distinct bounding shapes can be more accurately fitted for unique objects. This is especially true for situations when unique objects of interest are detected in close proximity to other objects, such as when a pedestrian is standing beside a vehicle.

More particularly, in some embodiments of the present disclosure, an autonomous vehicle and/or vehicle computing system can include or otherwise be communicatively coupled with one or more sensor systems. Sensor systems can include one or more cameras and/or one or more ranging systems including, for example, one or more Light Detection and Ranging (LIDAR) systems, and/or one or more Range Detection and Ranging (RADAR) systems. The sensor system(s) can capture a variety of sensor data (e.g., image data, ranging data (e.g., LIDAR data, RADAR data), etc.) at a plurality of successive time frames. For example, a LIDAR system can be configured to generate successive time frames of LIDAR data in successively obtained LIDAR sweeps around the 360-degree periphery of an autonomous vehicle. In some implementations, the sensor system including the LIDAR system is mounted on the autonomous vehicle, such as, for example, on the roof of the autonomous vehicle. For LIDAR-based object detection, for example, an object detection system can receive LIDAR data from one or more LIDAR systems configured to transmit ranging signals relative to an autonomous vehicle. In some embodiments, LIDAR data includes a three-dimensional point cloud of LIDAR data points received from around the periphery of an autonomous vehicle. Such sensor data (e.g., LIDAR data) can then be provided to a vehicle computing system, for example, for the detection, classification, and tracking of objects of interest during the operation of the autonomous vehicle.

In some implementations, sensor data (e.g., LIDAR data) can be configured in a variety of different representations. For example a first representation can correspond to a range-view representation of LIDAR data, which can include an approximately 360 degree side view of the LIDAR data (e.g., including LIDAR data points received from an approximately 360 degree horizontal periphery around the autonomous vehicle). Such a range-view representation can be characterized by a first dimension (e.g., height) corresponding to a number of channels (e.g., 32 channels, 64 channels) associated with the LIDAR system, and a second dimension corresponding to the angular range of the sensor (e.g., 360 degrees). Each LIDAR system channel can correspond, for example, to a unique light source (e.g., laser) from which a short light pulse (e.g., laser pulse) is emitted and a corresponding Time of Flight (TOF) distance measurement is received corresponding to the time it takes the pulse to travel from the sensor to an object and back.

Additionally, a second representation of sensor data can correspond to a different representation of the same sensor data. Such second representation can either be obtained directly from the sensor (e.g., the LIDAR system) or determined from the first representation of the sensor data obtained from the sensor (e.g., the LIDAR system). For example, a second representation of LIDAR data can correspond to a top-view representation. In contrast to the range-view representation of LIDAR data described above, a top-view representation can correspond to a representation of LIDAR data as viewed from a bird's eye or plan view relative to an autonomous vehicle and/or ground surface. A top-view representation of LIDAR data is generally from a vantage point that is substantially perpendicular to the vantage point of a range-view representation of the same data.

In some implementations, each representation of sensor data can be discretized into a grid of multiple cells, each cell within the grid corresponding to a segment in three-dimensional space. A range-view representation can correspond, for example, to a grid of multiple cells, wherein each cell within the grid can correspond to a horizontal segment (e.g., ray) in three-dimensional space. A top-view representation can correspond, for example, to a grid of multiple cells, wherein each cell within the grid can correspond to a vertical segment (e.g., column) in three-dimensional space. The LIDAR data can include a plurality of LIDAR data points that are projected onto respective cells within the grid of multiple cells associated with each respective representation of the LIDAR data.

More particularly, in some implementations, detecting objects of interest within a representation of LIDAR data can include determining one or more cell statistics characterizing the LIDAR data corresponding to each cell. In some examples, the one or more cell statistics can include, for example, one or more parameters associated with a distribution of LIDAR data points projected onto each cell. For instance, such parameters can include the number of LIDAR data points projected onto each cell, the average, variance, range, minimum and/or maximum value of a parameter for each LIDAR data point. In some examples, the one or more cell statistics can include, for example, one or more parameters associated with a power or intensity of LIDAR data points projected onto each cell.

In some implementations, detecting objects within a representation of LIDAR data can include determining a feature extraction vector for each cell based at least in part on the one or more cell statistics for that cell. Additionally or alternatively, a feature extraction vector for each cell can be based at least in part on the one or more cell statistics for surrounding cells. More particularly, in some examples, a feature extraction vector aggregates one or more cell statistics of surrounding cells at one or more different scales. For example, a first scale can correspond to a first group of cells that includes only a given cell. Cell statistics for the first group of cells (e.g., the given cell) can be calculated, a function can be determined based on those cell statistics, and the determined function can be included in a feature extraction vector. A second scale can correspond to a second group of cells that includes the given cell as well as a subset of cells surrounding the given cell. Cell statistics for the second group of cells can be calculated, a function can be determined based on those cell statistics, and the determined function can be appended to the feature extraction vector. A third scale can correspond to a third group of cells that includes the given cell as well as a subset of cells surrounding the given cell, wherein the third group of cells is larger than the second group of cells. Cell statistics for the third group of cells can be calculated, a function can be determined based on those cell statistics, and the determined function can be appended to the feature extraction vector. This process can be continued for a predetermined number of scales until the predetermined number has been reached. Such a multi-scale technique for extracting features can be advantageous in detecting objects of interest having different sizes (e.g., vehicles versus pedestrians).

In some implementations, detecting objects of interest within a representation of LIDAR data can include determining a classification for each cell based at least in part on the one or more cell statistics. In some implementations, a classification for each cell can be determined based at least in part on the feature extraction vector determined for each cell. In some implementations, the classification for each cell can include an indication of whether that cell includes (or does not include) a detected object of interest. In some examples, the classification for each cell can include an indication of whether that cell includes a detected object of interest from a predetermined set of objects of interest (e.g., a vehicle, a bicycle, a pedestrian, etc.). In some examples, the classification for each cell can include a probability score associated with each classification indicating the likelihood that such cell includes one or more particular classes of objects of interest.

According to another aspect of the present disclosure, in some implementations, an object detection system can be configured to fit bounding shapes (e.g., two-dimensional or three-dimensional bounding boxes and/or bounding polygons) to detected objects of interest. In some implementations, the bounding shapes can be generated within the representation of sensor data (e.g., LIDAR data) having a greater number of total data points (e.g., cells). By processing a more comprehensive representation of sensor data from a top-view representation for the determination of bounding shapes, distinct bounding shapes can be more accurately fitted for unique objects. This is especially true for situations when unique objects of interest are detected in close proximity to other objects, such as when a pedestrian is standing beside a vehicle.

More particularly, in some implementations, generating bounding shapes within a different representation of LIDAR data (e.g., a second representation of LIDAR data) than the representation in which objects of interest are detected (e.g., a first representation of LIDAR data) can include correlating at least a portion of the second representation of LIDAR data to the portion of the first representation of LIDAR data that corresponds to each of the detected objects of interest. By correlating at least a portion of the second representation of LIDAR data to the portion of the first representation of LIDAR data that corresponds to each detected object, bounding shapes can be fitted within a second representation of LIDAR data without having to process the entire second representation for either object detection of bounding shape generation.

More particularly, in some implementations, generating bounding shapes within a second representation of LIDAR data can include generating a plurality of proposed bounding shapes positioned relative to each detected object of interest (e.g., cluster of cells having a similar classification). A score for each proposed bounding shape can be determined. In some examples, each score can be based at least in part on a number of cells having one or more predetermined classifications within each proposed bounding shape. The bounding shape ultimately determined for each corresponding cluster of cells (e.g., object instance) can be determined at least in part on the scores for each proposed bounding shape. In some examples, the ultimate bounding shape determination from the plurality of proposed bounding shapes can be additionally or alternatively based on a filtering technique (e.g., non-maximum suppression (NMS) analysis) of the proposed bounding shapes to remove and/or reduce any overlapping bounding boxes.

In some embodiments, the object detection system can include or otherwise access a machine-learned detector model to facilitate both the detection of potential objects of interest (or classification of data points within objects of interest) and generation of motion information for such detected objects (or data points). In some embodiments, the machine-learned detector model can include various models, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, convolutional neural networks, recurrent neural networks (e.g., long short-term memory recurrent neural networks), or other forms of neural networks.

According to some embodiments of the present disclosure, the data input into the machine-learned detector model can include at least the first representation of sensor data. In some embodiments, the data input into the machine-learned detector model can include the first representation of sensor data and the second representation of sensor data. In embodiments when the data input into the machine-learned detector model includes only the first representation of sensor data, the model can be trained in part to determine the second representation of sensor data from the first representation of sensor data. In some embodiments, the one or more representations of sensor data provided as input to the machine-learned detector model can be pre-processed to include determined characteristics for cells within the one or more representations. In response to receipt of the one or more representations of sensor data, an indication of whether each cell includes a detected object of interest can be received as an output of the machine-learned detector model. In addition, motion information for detected objects of interest can be simultaneously received as an output of the machine-learned detector model. By providing multiple time frames of sensor data to a machine-learned model, an object detection system according to embodiments of the present disclosure can more accurately detect objects of interest and predict object's short-term attributes (e.g., motion parameters such as location, velocity, acceleration, etc.)

In some implementations, when training the machine-learned detector model to detect objects of interest and generate motion information for detected objects, a detector training dataset can include a large number of previously obtained representations of sensor data and corresponding labels that describe corresponding objects detected within such sensor data and the associated motion information for such detected objects.

In one implementation, the detector training dataset can include a first portion of data corresponding to one or more representations of sensor data (e.g., LIDAR data) originating from a LIDAR system associated with an autonomous vehicle. The sensor data (e.g., LIDAR data) can, for example, be recorded while an autonomous vehicle is in navigational operation. The detector training dataset can further include a second portion of data corresponding to labels identifying corresponding objects detected within each portion of input sensor data as well as labels identifying motion information for each detected object. In some implementations, the labels can further include at least a bounding shape corresponding to each detected object of interest. In some implementations, the labels can additionally include a classification for each object of interest from a predetermined set of objects including one or more of a pedestrian, a vehicle, or a bicycle. The labels included within the second portion of data within the detector training dataset can be manually annotated, automatically annotated, or annotated using a combination of automatic labeling and manual labeling.

In some implementations, to train the detector model, a training computing system can input a first portion of a set of ground-truth data (e.g., the first portion of the detector training dataset corresponding to the one or more representations of sensor data) into the machine-learned detector model to be trained. In response to receipt of such first portion, the machine-learned detector model outputs detected objects and associated motion information. This output of the machine-learned detector model predicts the remainder of the set of ground-truth data (e.g., the second portion of the detector training dataset). After such prediction, the training computing system can apply or otherwise determine a loss function that compares the object detections and associated motion information output by the machine-learned detector model to the remainder of the ground-truth data which the detector model attempted to predict. The training computing system then can backpropagate the loss function through the detector model to train the detector model (e.g., by modifying one or more weights associated with the detector model). This process of inputting ground-truth data, determining a loss function, and backpropagating the loss function through the detector model can be repeated numerous times as part of training the detector model. For example, the process can be repeated for each of numerous sets of ground-truth data provided within the detector training dataset.

An autonomous vehicle can include a sensor system as described above as well as a vehicle computing system. The vehicle computing system can include one or more computing devices and one or more vehicle controls. The one or more computing devices can include a perception system, a prediction system, and a motion planning system that cooperate to perceive the surrounding environment of the autonomous vehicle and determine a motion plan for controlling the motion of the autonomous vehicle accordingly. The vehicle computing system can receive sensor data from the sensor system as described above and utilize such sensor data in the ultimate motion planning of the autonomous vehicle.

The perception system can identify one or more objects that are proximate to the autonomous vehicle based on sensor data received from the one or more sensor systems. In particular, in some implementations, the perception system can determine, for each object, state data that describes a current state of such object. As examples, the state data for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle versus pedestrian versus bicycle versus other); yaw rate; and/or other state information. In some implementations, the perception system can determine state data for each object over a number of iterations. In particular, the perception system can update the state data for each object at each iteration. Thus, the perception system can detect and track objects (e.g., vehicles, bicycles, pedestrians, etc.) that are proximate to the autonomous vehicle over time, and thereby produce a presentation of the world around an autonomous vehicle along with its state (e.g., a presentation of the objects of interest within a scene at the current time along with the states of the objects).

The prediction system can receive the state data from the perception system and predict one or more future locations and/or moving paths for each object based on such state data. For example, the prediction system can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system can determine a motion plan for the autonomous vehicle based at least in part on one or more predicted future locations and/or moving paths for the object and/or the state data for the object provided by the perception system. Stated differently, given information about the current locations of objects and/or predicted future locations and/or moving paths of proximate objects, the motion planning system can determine a motion plan for the autonomous vehicle that best navigates the autonomous vehicle along the determined travel route relative to the objects at such locations.

As one example, in some implementations, the motion planning system can determine a cost function for each of one or more candidate motion plans for the autonomous vehicle based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle approaches impact with another object and/or deviates from a preferred pathway (e.g., a predetermined travel route).

Thus, given information about the current locations and/or predicted future locations and/or moving paths of objects, the motion planning system can determine a cost of adhering to a particular candidate pathway. The motion planning system can select or determine a motion plan for the autonomous vehicle based at least in part on the cost function(s). For example, the motion plan that minimizes the cost function can be selected or otherwise determined. The motion planning system then can provide the selected motion plan to a vehicle controller that controls one or more vehicle controls (e.g., actuators or other devices that control gas flow, steering, braking, etc.) to execute the selected motion plan.

The systems and methods described herein may provide a number of technical effects and benefits. By determining the location of objects and/or points within sensor data and also simultaneously determining motion information associated with such objects and/or points as described herein, an object detection system according to embodiments of the present disclosure can provide a technical effect and benefit of more accurately detecting objects of interest and thereby improving the classification and tracking of such objects of interest in a perception system of an autonomous vehicle. Object detection can be improved, for example, at least in part because a more comprehensive dataset is considered by providing multiple time frames of sensor data to a detector model. Such improved object detection accuracy can be particularly advantageous for use in conjunction with vehicle computing systems for autonomous vehicles. Because vehicle computing systems for autonomous vehicles are tasked with repeatedly detecting and analyzing objects in sensor data for tracking and classification of objects of interest (including other vehicles, cyclists, pedestrians, traffic control devices, and the like) and then determining necessary responses to such objects of interest, improved object detection accuracy allows for faster and more accurate object tracking and classification. Improved object tracking and classification can have a direct effect on the provision of safer and smoother automated control of vehicle systems and improved overall performance of autonomous vehicles.

The systems and methods described herein may also provide a technical effect and benefit of reducing potential noise in the association and tracking of detected objects of interest. Because motion information (e.g., motion parameters) is more immediately available for detected objects, the determined motion parameter estimates for such parameters as velocity and acceleration can be compared over time. Based on the short-term motion trends determined from such motion information, spurious detections and/or inaccurate motion parameters can be smoothed or corrected during processing. This can help eliminate unnecessary braking and/or swerving motions during implementation of a vehicle motion plan.

The systems and methods described herein may also provide resulting improvements to computing technology tasked with object detection, tracking, and classification. The systems and methods described herein may provide improvements in the speed and accuracy of object detection and classification, resulting in improved operational speed and reduced processing requirements for vehicle computing systems, and ultimately more efficient vehicle control.

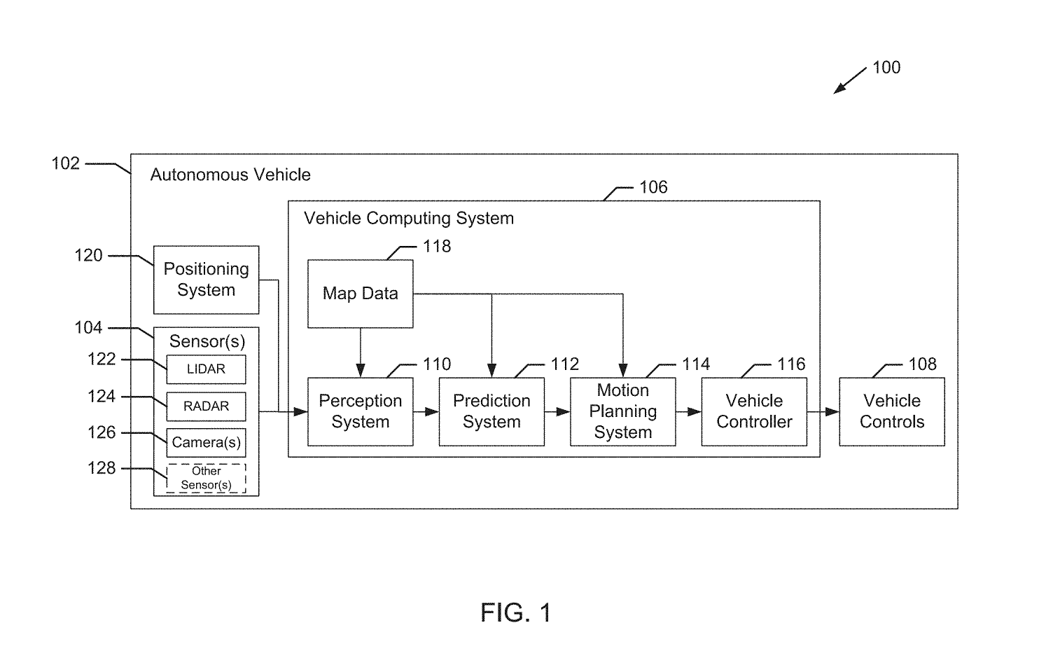

FIG. 1 depicts a block diagram of an example system 100 for controlling the navigation of an autonomous vehicle 102 according to example embodiments of the present disclosure. The autonomous vehicle 102 is capable of sensing its environment and navigating with little to no human input. The autonomous vehicle 102 can be a ground-based autonomous vehicle (e.g., car, truck, bus, etc.), an air-based autonomous vehicle (e.g., airplane, drone, helicopter, or other aircraft), or other types of vehicles (e.g., watercraft). The autonomous vehicle 102 can be configured to operate in one or more modes, for example, a fully autonomous operational mode and/or a semi-autonomous operational mode. A fully autonomous (e.g., self-driving) operational mode can be one in which the autonomous vehicle can provide driving and navigational operation with minimal and/or no interaction from a human driver present in the vehicle. A semi-autonomous (e.g., driver-assisted) operational mode can be one in which the autonomous vehicle operates with some interaction from a human driver present in the vehicle.

The autonomous vehicle 102 can include a sensor system with one or more sensors 104, a vehicle computing system 106, and one or more vehicle controls 108. The vehicle computing system 106 can assist in controlling the autonomous vehicle 102. In particular, the vehicle computing system 106 can receive sensor data from the one or more sensors 104, attempt to comprehend the surrounding environment by performing various processing techniques on data collected by the sensor(s) 104, and generate an appropriate motion path through such surrounding environment. The vehicle computing system 106 can control the one or more vehicle controls 108 to operate the autonomous vehicle 102 according to the motion path.

In some implementations, vehicle computing system 106 can further be connected to, or include, a positioning system 120. Positioning system 120 can determine a current geographic location of the autonomous vehicle 102. The positioning system 120 can be any device or circuitry for analyzing the position of the autonomous vehicle 102. For example, the positioning system 120 can determine actual or relative position by using a satellite navigation positioning system (e.g. a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position. The position of the autonomous vehicle 102 can be used by various systems of the vehicle computing system 106.

As illustrated in FIG. 1, in some embodiments, the vehicle computing system 106 can include a perception system 110, a prediction system 112, and a motion planning system 114 that cooperate to perceive the surrounding environment of the autonomous vehicle 102 and determine a motion plan for controlling the motion of the autonomous vehicle 102 accordingly.

In particular, in some implementations, the perception system 110 can receive sensor data from the one or more sensors 104 that are coupled to or otherwise included within the autonomous vehicle 102. As examples, the one or more sensors 104 can include a Light Detection and Ranging (LIDAR) system 122, a Radio Detection and Ranging (RADAR) system 124, one or more cameras 126 (e.g., visible spectrum cameras, infrared cameras, etc.), and/or other sensors 128. The sensor data can include information that describes the location of objects within the surrounding environment of the autonomous vehicle 102. In some implementations, the one or more sensor(s) can be configured to generate multiple time frames of data descriptive of the environment surrounding autonomous vehicle 102.

As one example, for LIDAR system 122, the sensor data can include the location (e.g., in three-dimensional space relative to the LIDAR system 122) of a number of points that correspond to objects that have reflected a ranging laser. For example, LIDAR system 122 can measure distances by measuring the Time of Flight (TOF) that it takes a short laser pulse to travel from the sensor to an object and back, calculating the distance from the known speed of light.

As another example, for RADAR system 124, the sensor data can include the location (e.g., in three-dimensional space relative to RADAR system 124) of a number of points that correspond to objects that have reflected a ranging radio wave. For example, radio waves (pulsed or continuous) transmitted by the RADAR system 124 can reflect off an object and return to a receiver of the RADAR system 124, giving information about the object's location and speed. Thus, RADAR system 124 can provide useful information about the current speed of an object.

As yet another example, for one or more cameras 126, various processing techniques (e.g., range imaging techniques such as, for example, structure from motion, structured light, stereo triangulation, and/or other techniques) can be performed to identify the location (e.g., in three-dimensional space relative to the one or more cameras 126) of a number of points that correspond to objects that are depicted in imagery captured by the one or more cameras 126. Other sensor systems 128 can identify the location of points that correspond to objects as well.

Thus, the one or more sensors 104 can be used to collect sensor data that includes information that describes the location (e.g., in three-dimensional space relative to the autonomous vehicle 102) of points that correspond to objects within the surrounding environment of the autonomous vehicle 102.

In addition to the sensor data, the perception system 110 can retrieve or otherwise obtain map data 118 that provides detailed information about the surrounding environment of the autonomous vehicle 102. The map data 118 can provide information regarding: the identity and location of different travel ways (e.g., roadways), road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way); traffic control data (e.g., the location and instructions of signage, traffic lights, or other traffic control devices); and/or any other map data that provides information that assists the vehicle computing system 106 in comprehending and perceiving its surrounding environment and its relationship thereto.

The perception system 110 can identify one or more objects that are proximate to the autonomous vehicle 102 based on sensor data received from the one or more sensors 104 and/or the map data 118. In particular, in some implementations, the perception system 110 can determine, for each object, state data that describes a current state of such object. As examples, the state data for each object can describe an estimate of the object's: current location (also referred to as position); current speed; current heading (also referred to together as velocity); current acceleration; current orientation; size/footprint (e.g., as represented by a bounding shape such as a bounding polygon or polyhedron); class (e.g., vehicle versus pedestrian versus bicycle versus other); yaw rate; and/or other state information.

In some implementations, the perception system 110 can determine state data for each object over a number of iterations. In particular, the perception system 110 can update the state data for each object at each iteration. Thus, the perception system 110 can detect and track objects (e.g., vehicles, pedestrians, bicycles, and the like) that are proximate to the autonomous vehicle 102 over time.

The prediction system 112 can receive the state data from the perception system 110 and predict one or more future locations and/or moving paths for each object based on such state data. For example, the prediction system 112 can predict where each object will be located within the next 5 seconds, 10 seconds, 20 seconds, etc. As one example, an object can be predicted to adhere to its current trajectory according to its current speed. As another example, other, more sophisticated prediction techniques or modeling can be used.

The motion planning system 114 can determine a motion plan for the autonomous vehicle 102 based at least in part on the predicted one or more future locations and/or moving paths for the object provided by the prediction system 112 and/or the state data for the object provided by the perception system 110. Stated differently, given information about the current locations of objects and/or predicted future locations and/or moving paths of proximate objects, the motion planning system 114 can determine a motion plan for the autonomous vehicle 102 that best navigates the autonomous vehicle 102 relative to the objects at such locations.

As one example, in some implementations, the motion planning system 114 can determine a cost function for each of one or more candidate motion plans for the autonomous vehicle 102 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 102 approaches a possible impact with another object and/or deviates from a preferred pathway (e.g., a preapproved pathway).

Thus, given information about the current locations and/or predicted future locations and/or moving paths of objects, the motion planning system 114 can determine a cost of adhering to a particular candidate pathway. The motion planning system 114 can select or determine a motion plan for the autonomous vehicle 102 based at least in part on the cost function(s). For example, the candidate motion plan that minimizes the cost function can be selected or otherwise determined. The motion planning system 114 can provide the selected motion plan to a vehicle controller 116 that controls one or more vehicle controls 108 (e.g., actuators or other devices that control gas flow, acceleration, steering, braking, etc.) to execute the selected motion plan.

Each of the perception system 110, the prediction system 112, the motion planning system 114, and the vehicle controller 116 can include computer logic utilized to provide desired functionality. In some implementations, each of the perception system 110, the prediction system 112, the motion planning system 114, and the vehicle controller 116 can be implemented in hardware, firmware, and/or software controlling a general purpose processor. For example, in some implementations, each of the perception system 110, the prediction system 112, the motion planning system 114, and the vehicle controller 116 includes program files stored on a storage device, loaded into a memory, and executed by one or more processors. In other implementations, each of the perception system 110, the prediction system 112, the motion planning system 114, and the vehicle controller 116 includes one or more sets of computer-executable instructions that are stored in a tangible computer-readable storage medium such as RAM hard disk or optical or magnetic media.

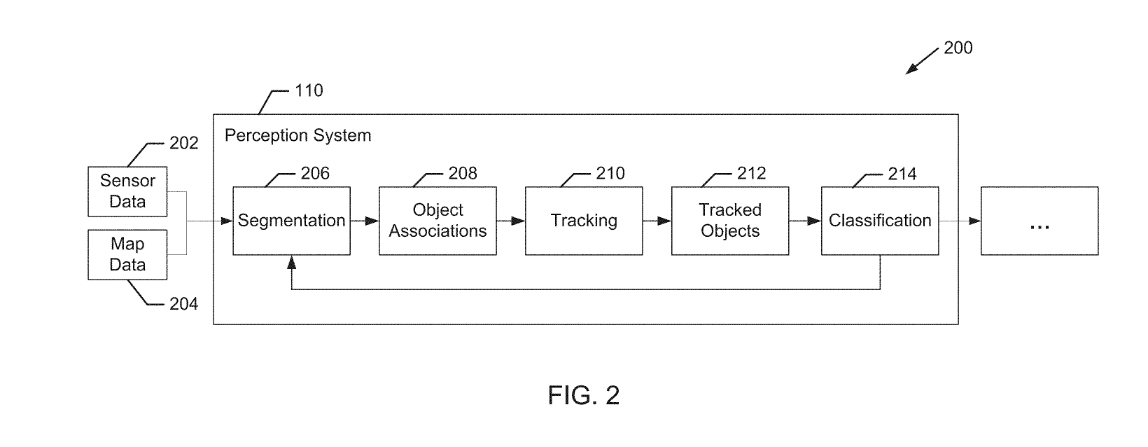

FIG. 2 depicts a block diagram of an example perception system 110 according to example embodiments of the present disclosure. As discussed in regard to FIG. 1, a vehicle computing system 106 can include a perception system 110 that can identify one or more objects that are proximate to an autonomous vehicle 102. In some embodiments, the perception system 110 can include segmentation system 206, object associations system 208, tracking system 210, tracked objects system 212, and classification system 214. The perception system 110 can receive sensor data 202 (e.g., from one or more sensors 104 of the autonomous vehicle 102) and optional map data 204 (e.g., corresponding to map data 118 of FIG. 1) as input. The perception system 110 can use the sensor data 202 and the map data 204 in determining objects within the surrounding environment of the autonomous vehicle 102. In some embodiments, the perception system 110 iteratively processes the sensor data 202 to detect, track, and classify objects identified within the sensor data 202. In some examples, the map data 204 can help localize the sensor data 202 to positional locations within a map or other reference system.

Within the perception system 110, the segmentation system 206 can process the received sensor data 202 and map data 204 to determine potential objects within the surrounding environment, for example using one or more object detection systems including the disclosed machine-learned detector model. The object associations system 208 can receive data about the determined objects and analyze prior object instance data to determine a most likely association of each determined object with a prior object instance, or in some cases, determine if the potential object is a new object instance.

The tracking system 210 can determine the current state of each object instance, for example, in terms of its current position, velocity, acceleration, heading, orientation, uncertainties, and/or the like. The tracked objects system 212 can receive data regarding the object instances and their associated state data and determine object instances to be tracked by the perception system 110. The classification system 214 can receive the data from tracked objects system 212 and classify each of the object instances. For example, classification system 214 can classify a tracked object as an object from a predetermined set of objects (e.g., a vehicle, bicycle, pedestrian, etc.). The perception system 110 can provide the object and state data for use by various other systems within the vehicle computing system 106, such as the prediction system 112 of FIG. 1.

Referring now to FIGS. 3-5, various representations of a single time frame of sensor data (e.g., LIDAR data) are represented. It should be appreciated that the multiple time frames of sensor data that are received from a sensor system and provided as input to a machine-learned detector model can correspond to one or more of the different representations of sensor data depicted in FIGS. 3-5 or to other representations of sensor data not illustrated herein but received by sensors of a vehicle.

FIG. 3 depicts example aspects of a first representation of LIDAR sensor data according to example embodiments of the present disclosure. In particular, FIG. 3 depicts a first range-view representation 300 and a second range-view representation 302. First range-view representation 300 provides a graphical depiction of LIDAR sensor data collected by a LIDAR system (e.g., LIDAR system 122 of autonomous vehicle 102 of FIG. 1). The first range-view representation can be associated with LIDAR data that indicates how far away an object is from the LIDAR system 122 (e.g., the distance to an object struck by a ranging laser beam from the LIDAR system 122). The LIDAR data associated with first range-view representation 300 depicts LIDAR points generated from a plurality of ranging laser beams being reflected from objects, with each row of the LIDAR data depicting points generated by each ranging laser beam. In FIG. 3, the LIDAR points are depicted using a colorized gray level to indicate the range of the LIDAR data points from the LIDAR system 122, with darker points being at a greater distance or range. In other implementations, LIDAR data associated with first range-view representation 300 can additionally or alternatively include LIDAR intensity data which indicates how much energy or power is returned to the LIDAR system 122 by the ranging laser beams being reflected from an object.

Second range-view representation 302 is similar to first range-view representation 300, but is discretized into a grid 304 of multiple cells. Grid 304 can be provided as a framework for characterizing the LIDAR data such that respective portions of the LIDAR data can be identified as corresponding to discrete cells within the grid 304 of multiple cells. The LIDAR data can include a plurality of LIDAR data points that are projected onto respective cells within the grid 304 of multiple cells.

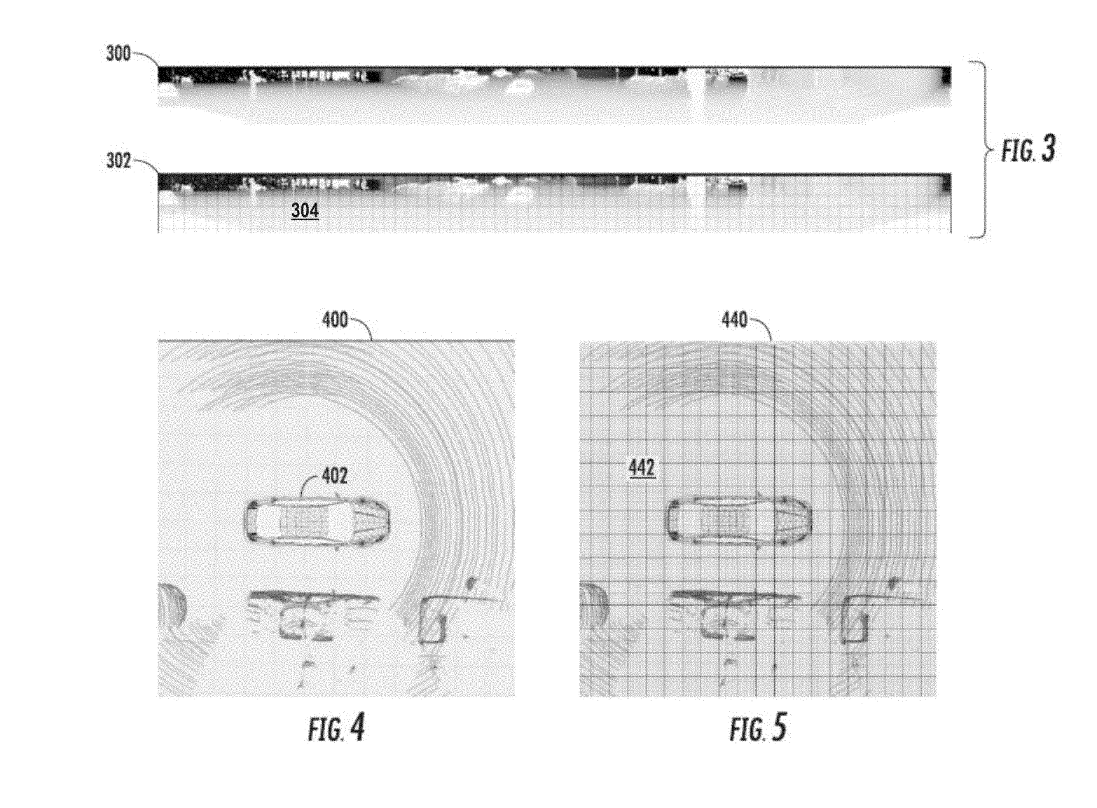

Referring now to FIGS. 4-5, various depictions of example top-view representations of LIDAR data are provided. FIG. 4 depicts an example top-view representation 400 of LIDAR data including a depiction of an autonomous vehicle 402 associated with a LIDAR system. In some implementations, autonomous vehicle 402 can correspond to autonomous vehicle 102 of FIG. 1, which is associated with LIDAR system 122. LIDAR system 122 can, for example, be mounted to a location on autonomous vehicle 402 and configured to transmit ranging signals relative to the autonomous vehicle 402 and to generate LIDAR data. The LIDAR data depicted in FIG. 4 can indicate how far away an object is from the LIDAR system (e.g., the distance to an object struck by a ranging laser beam from the LIDAR system associated with autonomous vehicle 402). The top-view representation 400 of LIDAR data illustrated in FIG. 4 depicts LIDAR points generated from a plurality of ranging laser beams being reflected from objects that are proximate to autonomous vehicle 402.

FIG. 5 provides an example top-view representation 440 of LIDAR data that is discretized into a grid 442 of multiple cells. Grid 442 can be provided as a framework for characterizing the LIDAR data such that respective portions of the LIDAR data can be identified as corresponding to discrete cells within the grid 442 of multiple cells. The LIDAR data can include a plurality of LIDAR data points that are projected onto respective cells within the grid 442 of multiple cells.

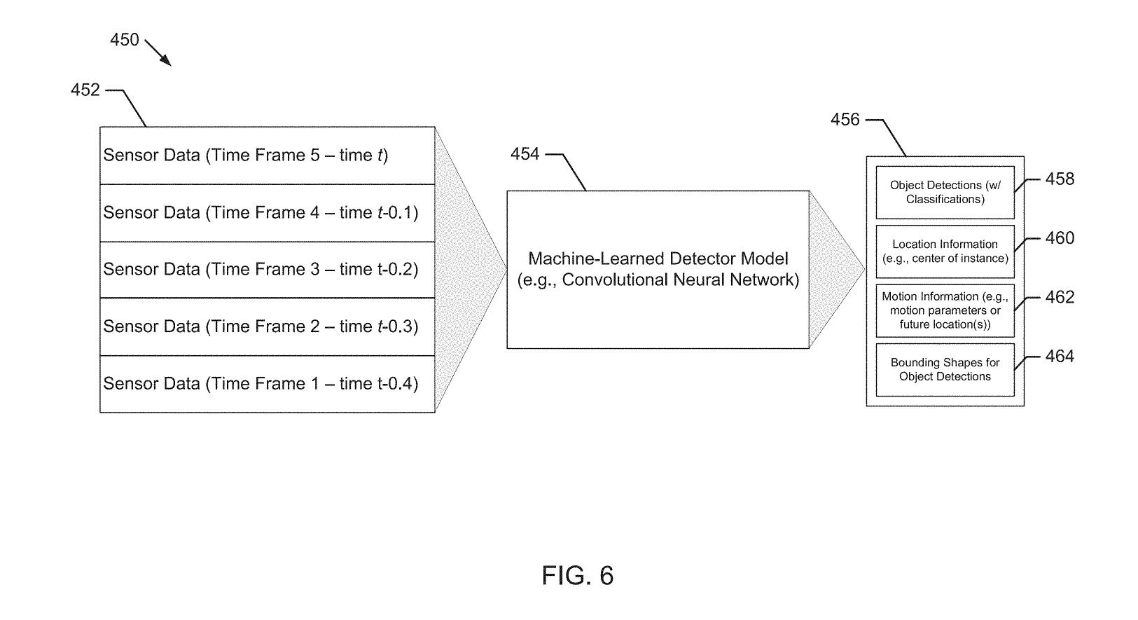

FIG. 6 depicts an example object detection system 450 according to example embodiments of the present disclosure. In some implementations, object detection system 450 can be part of perception system 110 or other portion of the autonomy stack within vehicle computing system 106 of autonomous vehicle 102. More particularly, object detection system 450 can include, for example, a machine-learned detector model 454. The machine-learned detector model 454 can have been trained to analyze multiple successive time frames of sensor data 452 (e.g., LIDAR data) to detect objects of interest and to generate motion information descriptive of the motion of each object of interest. When multiple time frames of sensor data 452 are provided as input to machine-learned detector model 454, output data 456 can be received as output of the machine-learned detector model 454. For example, output data 456 can include object detections 458, location information 460, motion information 462 and/or bounding shape information 464.

In some implementations, the multiple time frames of sensor data 452 include a buffer of N sensor data samples captured at different time intervals. In some implementations, the sensor data 452 are samples captured over a range of time (e.g., 0.5 seconds, 1 second, etc.). In some implementations, the sensor data 452 are samples captured at successive time frames that are spaced at equal intervals from one another. For example, in one implementation, the multiple time frames of sensor data 452 can include N sensor data samples captured at times t, t−0.1, t−0.2, . . . , t−(N−1)*0.1) seconds. The multiple time frames of sensor data 452 can be provided as input to machine-learned detector model 454. In some implementations, a buffer including multiple time frames of sensor data 452 can be provided as input to the machine-learned detector model 454, such that the multiple time frames of sensor data 452 are simultaneously provided as input to the machine-learned detector model 454.

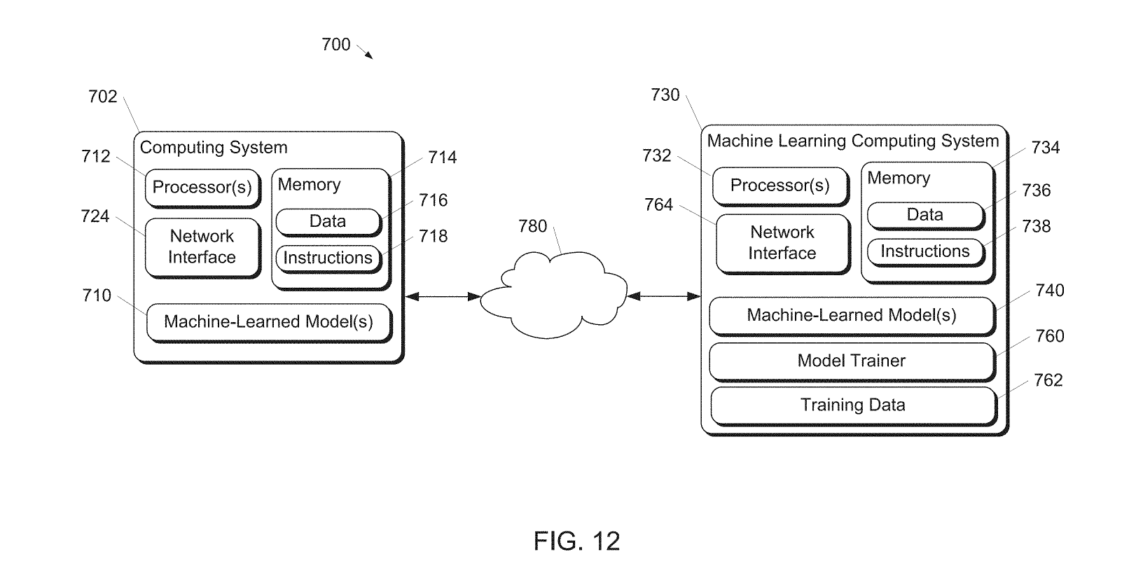

The machine-learned detector model 454 can include various models, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, convolutional neural networks, recurrent neural networks (e.g., long short-term memory recurrent neural networks), or other forms of neural networks. Additional details regarding the machine-learned detector model 454 and training of the model are discussed with reference to FIG. 12.

Machine-learned detector model 454 can be trained to generate output data 456 in response to receipt of the multiple time frames of sensor data 452 provided as input. The form of output data 456 can take a variety of different combinations and forms, depending on how the machine-learned detector model 454 is trained.

In some implementations, output data 456 can include object detections 458 with corresponding classifications. Classifications associated with object detections 458 can include, for example, a classification label associated with each detected object of interest. The classification label can include an indication of whether an object of interest is determined to correspond to a particular type of object of interest from a predetermined set of objects of interest (e.g., a vehicle, a bicycle, a pedestrian, etc.). In some examples, the classification for each object of interest can also include a confidence score associated with each classification indicating the probability that such classification is correct. When the machine-learned detector model 454 is trained to provide outputs for each data point of sensor data (as opposed to for detected objects of interest), the classification label and/or confidence scores associated with object detections 458 can be determined by the machine-learned detector model 454 for each data point.

In some implementations, output data 456 can include location information 460 associated with detected objects of interest (e.g., object detections 458). For example, location information 460 can be descriptive of the location of each detected object of interest (or sensor data point). Location information 460 can include, for example, a center point determined for each detected object of interest. In some implementations, the location information can include location of particular points, such as when machine-learned detector model 454 is trained to determine output data per data point as opposed to per object.

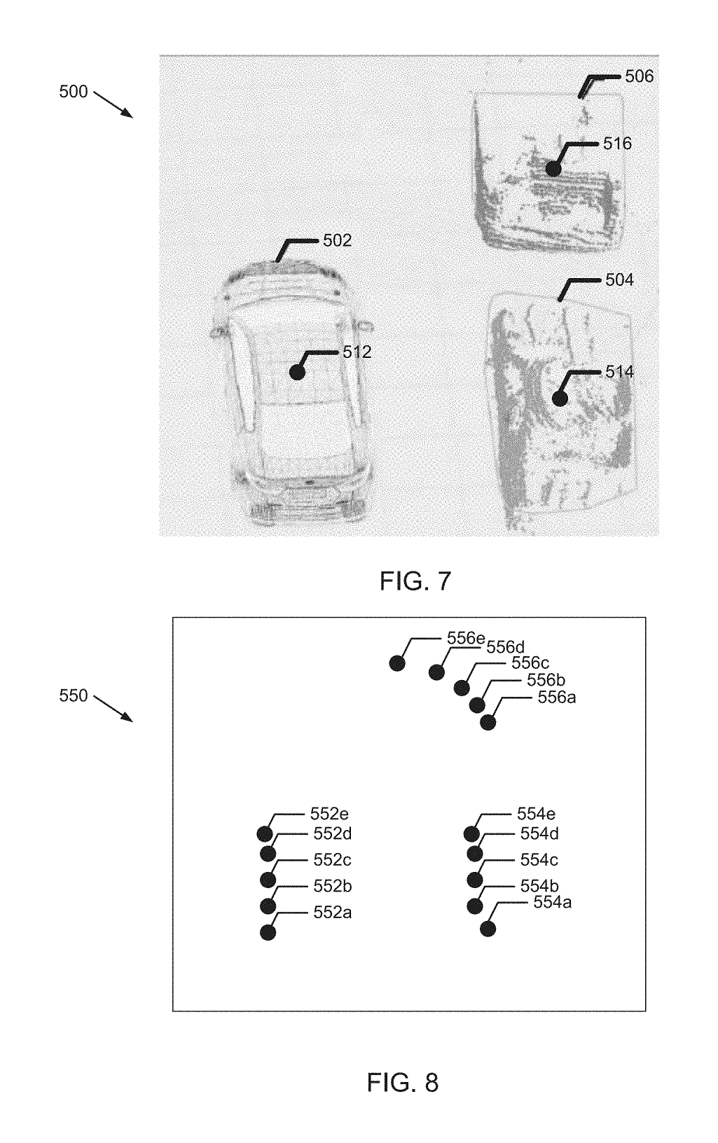

In some implementations, output data 456 can include motion information 462 associated with detected objects of interest (e.g., object detections 458). For example, motion information 462 can be descriptive of the motion of each detected object of interest (or sensor data point). In some implementations, the motion information 462 descriptive of the motion of each object of interest can include one or more parameters (e.g., velocity, acceleration, etc.) descriptive of the motion of each detected object of interest. In some implementations, the motion information 462 descriptive of the motion of each object of interest can include a location of each object of interest at one or more subsequent times after the given time (e.g., time t). In such instances, differences between the location of the object of interest at the given time and the one or more subsequent times can be used to determine the parameters of the motion information, such as velocity, acceleration and the like. To determine such motion parameters, the machine-learned detector model 454 can be configured to implement curve-fitting relative to each detected object of interest over the multiple time frames of sensor data to determine the parameters. Additional details of such curve-fitting are described with reference to FIGS. 7-10.

In some implementations, output data 456 can include bounding shape information 464 (e.g., information describing two-dimensional or three-dimensional bounding boxes and/or bounding polygons) associated with detected objects of interest (e.g., object detections 458). In some implementations, the bounding shape information 464 can be generated within the representation of sensor data (e.g., LIDAR data) having a greater number of total data points (e.g., cells). By processing a more comprehensive representation of sensor data from a top-view representation for the determination of bounding shape information 464, distinct bounding shapes can be more accurately fitted for unique objects. This is especially true for situations when unique objects of interest are detected in close proximity to other objects, such as when a pedestrian is standing beside a vehicle.

Referring now to FIGS. 7-10, additional examples of curve-fitting can be implemented by a machine-learned detector model (e.g., machine-learned detector model 454 of FIG. 6). FIG. 7 depicts an example representation of a first aspect of sensor data according to example embodiments of the disclosed technology. More particularly, FIG. 7 depicts a top-down sensor data representation 500 (e.g., LIDAR data representation). Sensor data representation 500 includes, for example, data associated with three objects of interest, namely vehicles 502, 504, and 506. Vehicle 502 can correspond to a vehicle including a sensor system that is used to obtain sensor data representation 500. For example, vehicle 502 can correspond to autonomous vehicle 102 of FIG. 1. Analysis of the LIDAR point cloud corresponding to sensor data representation 500 can result in the identification of a data point 512 corresponding to vehicle 502, a data point 514 corresponding to vehicle 504, and a data point 516 corresponding to vehicle 506. In some implementations, data points 512, 514, and 516 can correspond to one of many data points that are evaluated for each of vehicles 502, 504, and 506. In some implementations, data points 512, 514, and 516 are center points to represent each instance of a detected object (namely, vehicles 502, 504, and 506). Either way, the location information associated with data points 512, 514, and 516 can be associated with object detections of vehicles 502, 504, and 506.

FIG. 8 depicts an exemplary representation of a second aspect of sensor data according to example embodiments of the disclosed technology. More particularly, sensor data representation 550 of FIG. 8 corresponds to at least a portion of multiple time frames of sensor data points. For example, sensor data points 552a-552e can correspond to consecutive samples (e.g., multiple time frames) of a sensor data point such as data point 512 of FIG. 7. Similarly, sensor data points 554a-554e and 556a-556e can correspond respectively to consecutive samples (e.g. multiple time frames) of sensor data points such as sensor data points 514 and 516 of FIG. 7.

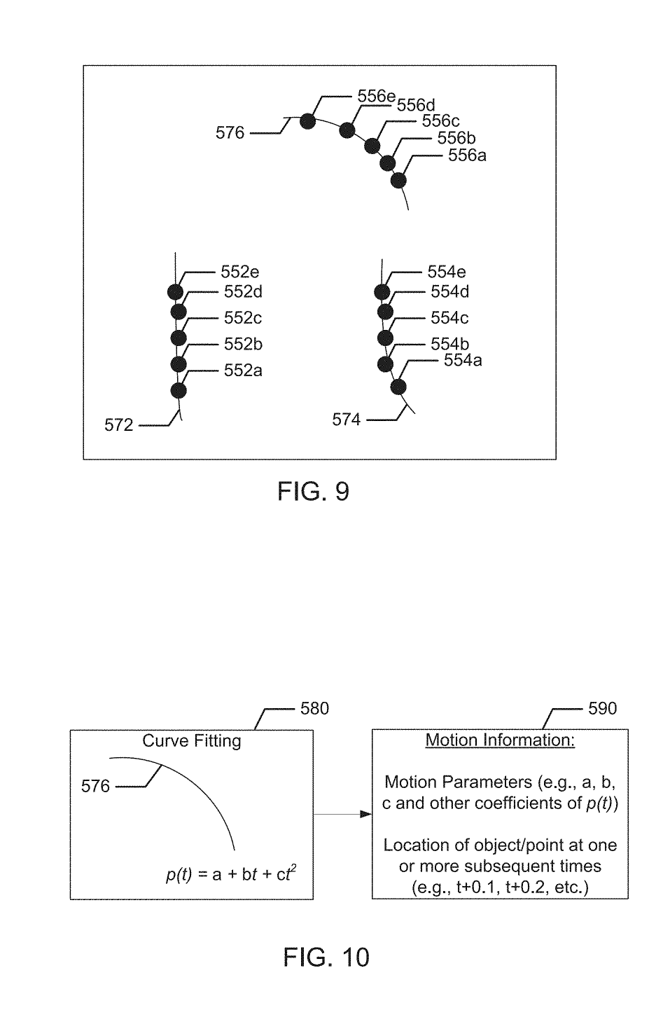

FIG. 9 depicts an exemplary representation of a first aspect of curve fitting to sensor data according to example embodiments of the disclosed technology. More particularly, the representation of FIG. 9 depicts how a machine-learned detector model (e.g., machine-learned detector model 454 of FIG. 6) can implement curve-fitting relative to multiple time frames of sensor data. For example, multiple time frames of sensor data, a portion of which can be represented by data points 552a-552e, 554a-554e, and 556a-556e, are provided as input to a machine-learned detector model. The machine-learned detector model can be configured to implement curve-fitting relative to each set of consecutively sampled data points or detected objects. Curve-fitting can be employed to determine a curve for each set of data points or detected objects over time. As such a machine-learned detector model can learn to generate a curve 572 that is fit to data points 552-552e, a curve 574 that is fit to data points 554a-554e, and a curve 576 that is fit to data points 556a-556e. Any of a variety of curve-fitting procedures can be employed to generate curves 572, 574, and 576, although one particular example involves a polynomial fitting of a location of each detected object of interest over multiple time frames (e.g., as represented by respective sets of data points 552a-552e, 554a-554e, and 556a-556e) to a polynomial having a plurality of coefficients.

FIG. 10 depicts an exemplary representation of a second aspect of curve fitting to sensor data according to example embodiments of the disclosed technology. More particularly, FIG. 10 includes a portion of curve-fitting data 580 as well as a corresponding portion of motion information determined from the curve-fitting data. For example, curve fitting data 580 depicts how curve 576 can be generated by fitting data points 556a-556e of FIGS. 8-9 to a polynomial, such as a polynomial of form p(t)=a+bt+ct². From the curve-fitting data 580, motion information 590 can be determined. In some implementations, the one or more parameters included in the motion information 590 can be determined, based on the curve-fitting, from the plurality of coefficients (e.g., a, b and c) of the polynomial depicted in the curve fitting data 580. For instance, a polynomial p(t) of the second order (e.g., p(t)=a+bt+ct²) can be employed in the curve-fitting, where the first term (a) is a bias term describing the location of a detected object, the second term (bt) includes a coefficient “b” representing the velocity of the detected object, and the third term (ct²) includes a coefficient “c” representing the acceleration of the detected object. There can also be higher order terms in the curve-fitting polynomial.

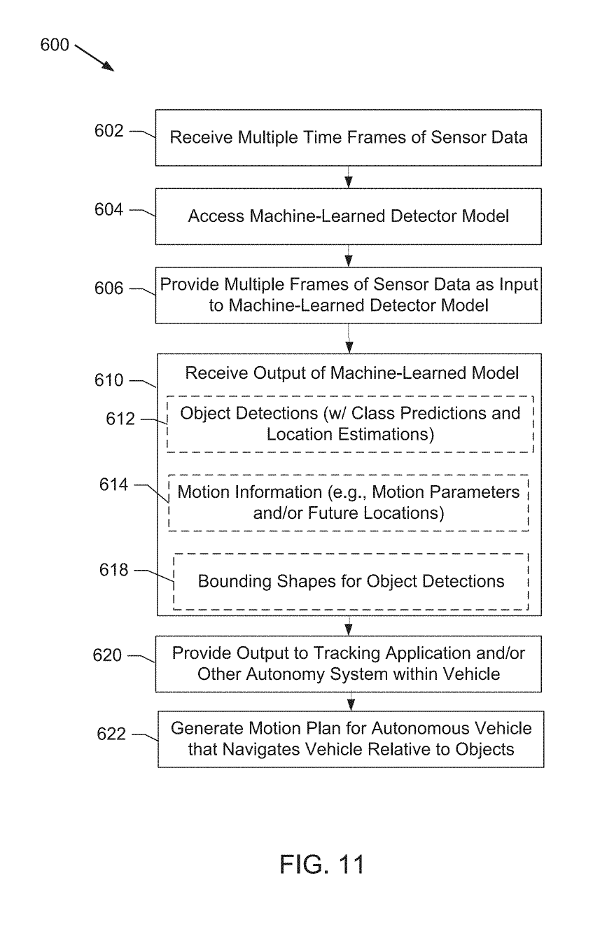

FIG. 11 depicts a flow chart diagram of an example method according to example aspects of the present disclosure. One or more portion(s) of the method 600 can be implemented by one or more computing devices such as, for example, computing device(s) within vehicle computing system 106 of FIG. 1, or computing system 702 of FIG. 12. Moreover, one or more portion(s) of the method 600 can be implemented as an algorithm on the hardware components of the device(s) described herein (e.g., as in FIGS. 1, 2, 6, and 12) to, for example, detect objects within sensor data and determine motion information associated with such objects and/or data points.

At 602, one or more computing devices within a computing system can receive multiple time frames of sensor data (e.g., LIDAR data) descriptive of an environment surrounding an autonomous vehicle. In some implementations, the sensor data comprises a point cloud of light detection and ranging (LIDAR) data configured in a top-view representation. Such LIDAR data can include data regarding locations of points associated with objects within a surrounding environment of an autonomous vehicle (e.g., data indicating the locations (relative to the LIDAR device) of a number of points that correspond to objects that have reflected a ranging laser). For example, in some embodiments, the multiple time frames of sensor data received at 602 can be generated by a sweep builder to include an approximately 360 degree view of the LIDAR sensor data (e.g., including LIDAR data points received from an approximately 360 degree horizontal periphery around the autonomous vehicle). This 360 degree view can be obtained at multiple successive time frames to obtain a time buffer of sensor data.

In some implementations, the multiple time frames of sensor data received at 602 can include at least a first time frame of sensor data, a second time frame of sensor data, and a third time frame of sensor data. In some implementations, the multiple time frames of sensor data received at 602 can include at least a first time frame of sensor data, a second time frame of sensor data, a third time frame of sensor data, a fourth time frame of sensor data, and a fifth time frame of sensor data. In some implementations, each time frame of sensor data received at 602 is periodically spaced in time from an adjacent time frame of sensor data.

At 604, one or more computing devices within a computing system can access a machine-learned detector model that is configured to implement curve-fitting of sensor data points over the multiple time frames of sensor data. In some implementations, the machine-learned detector model accessed at 604 can have been trained to analyze multiple time frames of sensor data (e.g., LIDAR data) to detect objects of interest and to implement curve-fitting of LIDAR data points over the multiple time frames to determine one or more motion parameters descriptive of the motion of each detected object of interest. In some implementations, the machine-learned detector model accessed at 604 can have been trained to determine motion information descriptive of the motion of each point in a point cloud of LIDAR data. In some embodiments, the machine-learned detector model accessed at 604 can correspond to the machine-learned detector model 454 as depicted in FIG. 6, or one of the machine-learned detector models 710 and/or 740 depicted in FIG. 12.

At 606, one or more computing devices within a computing system can provide the multiple frames of sensor data received at 602 as input to the machine-learned detector model accessed at 604. The machine-learned detector model can be configured to implement curve-fitting of the sensor data points over the multiple time frames to determine one or more motion parameters descriptive of the motion of each detected object of interest. In some implementations, the curve-fitting corresponds to a polynomial fitting of a location of each detected object of interest over the multiple time frames to a polynomial having a plurality of coefficients. The one or more motion parameters can thus be determined based on the plurality of coefficients of the polynomial.

At 610, one or more computing devices within a computing system can receive an output of the machine-learned model, in response to receipt of the input data provided at 606. In some implementations, receiving at 610 the output of the machine-learned detector model can more particularly include receiving at 612 class predictions and/or location information associated with data points of the sensor data or with objects detected within the sensor data. In some implementations, receiving at 610 the output of the machine-learned detector model can more particularly include receiving at 614 motion information associated with data points of the sensor data or with objects detected within the sensor data. The motion information received at 614 can include, for example, motion parameters associated with curves fit to the sensor data and/or predicted future locations from which the motion parameters can be derived). In some implementations, receiving at 610 the output of the machine-learned motion detector model can more particularly include receiving at 618 bounding shape information for object detections.

It should be appreciated that the machine-learned detector model can be trained to provide different combinations of outputs received at 612, 614, and/or 618. For example, in some implementations, the output of the machine-learned detector model received at 610 can include location information descriptive of a location of each object of interest detected within the environment at a given time (e.g., part of which is associated with output received at 612) and motion information descriptive of the motion of each object of interest (e.g., part of which is associated with output received at 614).

In some implementations, the motion information received at 614 can be descriptive of the motion of each object of interest and/or data point and can include one or more parameters, determined based on the curve-fitting, that are descriptive of the motion of each detected object of interest. In some implementations, the one or more parameters can include one or more of a velocity and an acceleration of each object of interest. In some implementations, the motion information received at 614 descriptive of the motion of each object of interest can include a location of each object of interest at one or more subsequent times after the given time.

At 620, one or more computing devices within a computing system can determine based on the location information and motion information for each object of interest, a predicted track for each object of interest over time relative to the autonomous vehicle. For instance, the sensor data, and/or associated location information and/or motion information and/or bounding shapes can be provided as output to a tracking application (e.g., a tracking application within perception system 110 of FIG. 1) and/or other autonomy computing systems (e.g., prediction system 112 and/or motion planning system 114) within a vehicle.

At 622, one or more computing devices within a computing system can generate a motion plan for an autonomous vehicle that navigates the vehicle relative to objects detected by the disclosed machine-learned detector model. In some implementations, the generation of a motion plan at 622 can be implemented by a motion planning system within a vehicle computing system, such as motion planning system 114 of FIG. 1.

FIG. 12 depicts a block diagram of an example computing system 700 according to example embodiments of the present disclosure. The example system 700 includes a computing system 702 and a machine learning computing system 730 that are communicatively coupled over a network 780.

In some implementations, the computing system 702 can perform autonomous vehicle motion planning including object detection, tracking, and/or classification (e.g., making object detections, class predictions, determining location information, determining motion information and/or generating bounding shapes as described herein). In some implementations, the computing system 702 can be included in an autonomous vehicle. For example, the computing system 702 can be on-board the autonomous vehicle. In other implementations, the computing system 702 is not located on-board the autonomous vehicle. For example, the computing system 702 can operate offline to perform object detection including determining location information and motion information for detected objects and/or data points. The computing system 702 can include one or more distinct physical computing devices.

The computing system 702 includes one or more processors 712 and a memory 714. The one or more processors 712 can be any suitable processing device (e.g., a processor core, a microprocessor, an ASIC, a FPGA, a controller, a microcontroller, etc.) and can be one processor or a plurality of processors that are operatively connected. The memory 714 can include one or more non-transitory computer-readable storage media, such as RAM, ROM, EEPROM, EPROM, one or more memory devices, flash memory devices, etc., and combinations thereof.

The memory 714 can store information that can be accessed by the one or more processors 712. For instance, the memory 714 (e.g., one or more non-transitory computer-readable storage mediums, memory devices) can store data 716 that can be obtained, received, accessed, written, manipulated, created, and/or stored. The data 716 can include, for instance, ranging data obtained by LIDAR system 122 and/or RADAR system 124, image data obtained by camera(s) 126, data identifying detected and/or classified objects including current object states and predicted object locations and/or motion information and/or trajectories, motion plans, machine-learned models, rules, etc. as described herein. In some implementations, the computing system 702 can obtain data from one or more memory device(s) that are remote from the system 702.

The memory 714 can also store computer-readable instructions 718 that can be executed by the one or more processors 712. The instructions 718 can be software written in any suitable programming language or can be implemented in hardware. Additionally, or alternatively, the instructions 718 can be executed in logically and/or virtually separate threads on processor(s) 712.

For example, the memory 714 can store instructions 718 that when executed by the one or more processors 712 cause the one or more processors 712 to perform any of the operations and/or functions described herein, including, for example, operations 602-622 of FIG. 11.

According to an aspect of the present disclosure, the computing system 702 can store or include one or more machine-learned models 710. As examples, the machine-learned models 710 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, convolutional neural networks, recurrent neural networks (e.g., long short-term memory recurrent neural networks), or other forms of neural networks.

In some implementations, the computing system 702 can receive the one or more machine-learned models 710 from the machine learning computing system 730 over network 780 and can store the one or more machine-learned models 710 in the memory 714. The computing system 702 can then use or otherwise implement the one or more machine-learned models 710 (e.g., by processor(s) 712). In particular, the computing system 702 can implement the machine learned model(s) 710 to perform object detection including determining location information and motion information for detected objects and/or data points using curve-fitting. For example, in some implementations, the computing system 702 can employ the machine-learned model(s) 710 by inputting multiple time frames of sensor data (e.g., sensor data 452 of FIG. 6) into the machine-learned model(s) 710 and receiving output data (e.g., output data 456 of FIG. 6) as an output of the machine-learned model(s) 710.

The machine learning computing system 730 includes one or more processors 732 and a memory 734. The one or more processors 732 can be any suitable processing device (e.g., a processor core, a microprocessor, an ASIC, a FPGA, a controller, a microcontroller, etc.) and can be one processor or a plurality of processors that are operatively connected. The memory 734 can include one or more non-transitory computer-readable storage media, such as RAM, ROM, EEPROM, EPROM, one or more memory devices, flash memory devices, etc., and combinations thereof.

The memory 734 can store information that can be accessed by the one or more processors 732. For instance, the memory 734 (e.g., one or more non-transitory computer-readable storage mediums, memory devices) can store data 736 that can be obtained, received, accessed, written, manipulated, created, and/or stored. The data 736 can include, for instance, ranging data, image data, data identifying detected and/or classified objects including current object states and predicted object locations and/or trajectories, motion plans, machine-learned models, rules, etc. as described herein. In some implementations, the machine learning computing system 730 can obtain data from one or more memory device(s) that are remote from the system 730.

The memory 734 can also store computer-readable instructions 738 that can be executed by the one or more processors 732. The instructions 738 can be software written in any suitable programming language or can be implemented in hardware. Additionally, or alternatively, the instructions 738 can be executed in logically and/or virtually separate threads on processor(s) 732.

For example, the memory 734 can store instructions 738 that when executed by the one or more processors 732 cause the one or more processors 732 to perform any of the operations and/or functions described herein, including, for example, operations 602-622 of FIG. 11.

In some implementations, the machine learning computing system 730 includes one or more server computing devices. If the machine learning computing system 730 includes multiple server computing devices, such server computing devices can operate according to various computing architectures, including, for example, sequential computing architectures, parallel computing architectures, or some combination thereof.

In addition or alternatively to the model(s) 710 at the computing system 702, the machine learning computing system 730 can include one or more machine-learned models 740. As examples, the machine-learned models 740 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, convolutional neural networks, recurrent neural networks (e.g., long short-term memory recurrent neural networks), or other forms of neural networks.

As an example, the machine learning computing system 730 can communicate with the computing system 702 according to a client-server relationship. For example, the machine learning computing system 730 can implement the machine-learned models 740 to provide a web service to the computing system 702. For example, the web service can provide an autonomous vehicle motion planning service.

Thus, machine-learned models 710 can be located and used at the computing system 702 and/or machine-learned models 740 can be located and used at the machine learning computing system 730.

In some implementations, the machine learning computing system 730 and/or the computing system 702 can train the machine-learned models 710 and/or 740 through use of a model trainer 760. The model trainer 760 can train the machine-learned models 710 and/or 740 using one or more training or learning algorithms. One example training technique is backwards propagation of errors. In some implementations, the model trainer 760 can perform supervised training techniques using a set of labeled training data. In other implementations, the model trainer 760 can perform unsupervised training techniques using a set of unlabeled training data. The model trainer 760 can perform a number of generalization techniques to improve the generalization capability of the models being trained. Generalization techniques include weight decays, dropouts, or other techniques.

In particular, the model trainer 760 can train a machine-learned model 710 and/or 740 based on a set of training data 762. The training data 762 can include, for example, a plurality of sets of ground truth data, each set of ground truth data including a first portion and a second portion. For example the training data 762 can include a large number of previously obtained representations of sensor data and corresponding labels that describe corresponding objects detected within such sensor data and the associated motion information for such detected objects.

In one implementation, the training data 762 can include a first portion of data corresponding to one or more representations of sensor data (e.g., LIDAR data) originating from a LIDAR system associated with an autonomous vehicle (e.g., autonomous vehicle 102 of FIG. 1). The sensor data (e.g., LIDAR data) can, for example, be recorded while an autonomous vehicle is in navigational operation. The training data 762 can further include a second portion of data corresponding to labels identifying corresponding objects detected within each portion of input sensor data as well as labels identifying motion information for each detected object. In some implementations, the labels can further include at least a bounding shape corresponding to each detected object of interest. In some implementations, the labels can additionally include a classification for each object of interest from a predetermined set of objects including one or more of a pedestrian, a vehicle, or a bicycle. The labels included within the second portion of data within the training data 762 can be manually annotated, automatically annotated, or annotated using a combination of automatic labeling and manual labeling.

In some implementations, to train the machine-learned detector model (e.g., machine-learned detector model(s) 710 and/or 740), model trainer 760 can input a first portion of a set of ground-truth data (e.g., the first portion of the training data 762 corresponding to the one or more representations of sensor data) into the machine-learned detector model (e.g., machine-learned detector model(s) 710 and/or 740) to be trained. In response to receipt of such first portion, the machine-learned detector model outputs detected objects and associated motion information. This output of the machine-learned detector model predicts the remainder of the set of ground-truth data (e.g., the second portion of the detector training dataset). After such prediction, the model trainer 760 can apply or otherwise determine a loss function that compares the object detections and associated motion information output by the machine-learned detector model (e.g., machine-learned detector model(s) 710 and/or 740) to the remainder of the ground-truth data which the detector model attempted to predict. The model trainer 760 then can backpropagate the loss function through the detector model (e.g., machine-learned detector model(s) 710 and/or 740) to train the detector model (e.g., by modifying one or more weights associated with the detector model). This process of inputting ground-truth data, determining a loss function, and backpropagating the loss function through the detector model can be repeated numerous times as part of training the detector model. For example, the process can be repeated for each of numerous sets of ground-truth data provided within the training data 762. The model trainer 760 can be implemented in hardware, firmware, and/or software controlling one or more processors.

The computing system 702 can also include a network interface 724 used to communicate with one or more systems or devices, including systems or devices that are remotely located from the computing system 702. The network interface 724 can include any circuits, components, software, etc. for communicating with one or more networks (e.g., 780). In some implementations, the network interface 724 can include, for example, one or more of a communications controller, receiver, transceiver, transmitter, port, conductors, software, and/or hardware for communicating data. Similarly, the machine learning computing system 730 can include a network interface 764.

The network(s) 780 can be any type of network or combination of networks that allows for communication between devices. In some embodiments, the network(s) can include one or more of a local area network, wide area network, the Internet, secure network, cellular network, mesh network, peer-to-peer communication link, and/or some combination thereof, and can include any number of wired or wireless links. Communication over the network(s) 780 can be accomplished, for instance, via a network interface using any type of protocol, protection scheme, encoding, format, packaging, etc.

FIG. 12 illustrates one example computing system 700 that can be used to implement the present disclosure. Other computing systems can be used as well. For example, in some implementations, the computing system 702 can include the model trainer 760 and the training dataset 762. In such implementations, the machine-learned models 710 can be both trained and used locally at the computing system 702. As another example, in some implementations, the computing system 702 is not connected to other computing systems.

In addition, components illustrated and/or discussed as being included in one of the computing systems 702 or 730 can instead be included in another of the computing systems 702 or 730. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method, comprising:
receiving, by a computing system comprising one or more computing devices, multiple time frames of sensor data descriptive of an environment surrounding an autonomous vehicle;
inputting, by the computing system, the multiple time frames of sensor data to a machine-learned detector model that is configured to implement curve-fitting of sensor data points over the multiple time frames of sensor data;
receiving, by the computing system as an output of the machine-learned detector model, location information descriptive of a location of each object of interest detected within the environment at a given time and motion information descriptive of a motion of each object of interest; and
determining, by the computing system and based on the location information and the motion information for each object of interest, a predicted track for each object of interest over time relative to the autonomous vehicle.

2. The computer-implemented method of claim 1, wherein the motion information descriptive of the motion of each object of interest comprises one or more parameters, determined based on the curve-fitting, that are descriptive of the motion of each detected object of interest.

3. The computer-implemented method of claim 2, wherein the one or more parameters comprise one or more of a velocity and an acceleration of each object of interest.

4. The computer-implemented method of claim 2, wherein the curve-fitting comprises a polynomial fitting of a location of each detected object of interest over the multiple time frames to a polynomial having a plurality of coefficients, and wherein the one or more parameters are determined based on the plurality of coefficients of the polynomial.

5. The computer-implemented method of claim 1, wherein the motion information descriptive of the motion of each object of interest comprises a location of each object of interest at one or more subsequent times after the given time.

6. The computer-implemented method of claim 1, wherein the sensor data comprises a point cloud of light detection and ranging (LIDAR) data configured in one or more of a top-view representation and a range-view representation.

7. The computer-implemented method of claim 6, wherein the machine-learned detector model is trained to determine motion information descriptive of a motion of each point in the point cloud of LIDAR data.

8. The computer-implemented method of claim 1, further comprising determining, by the computing system, a motion plan for the autonomous vehicle that navigates the autonomous vehicle relative to the one or more objects of interest.

9. The computer-implemented method of claim 1, wherein:
the multiple time frames of sensor data comprise at least a first time frame of sensor data, a second time frame of sensor data, and a third time frame of sensor data; and
wherein each time frame of sensor data is periodically spaced in time from an adjacent time frame of sensor data.

10. A computing system, comprising:
a light detection and ranging (LIDAR) system configured to gather successive time frames of LIDAR data descriptive of an environment surrounding an autonomous vehicle;
one or more processors;
a machine-learned detector model that has been trained to analyze multiple time frames of LIDAR data to detect objects of interest and to implement curve-fitting of LIDAR data points over the multiple time frames to determine one or more motion parameters descriptive of the motion of each detected object of interest;
at least one tangible, non-transitory computer readable medium that stores instructions that, when executed by the one or more processors, cause the one or more processors to perform operations, the operations comprising:
providing multiple time frames of LIDAR data to the machine-learned detector model; and
receiving as an output of the machine-learned detector model, location information descriptive of a location of each object of interest detected within the environment at a given time and motion information descriptive of the motion of each object of interest.

11. The computing system of claim 10, wherein the motion information descriptive of the motion of each object of interest comprises one or more parameters, determined based on the curve-fitting, that comprise a velocity and an acceleration of each object of interest.

12. The computing system of claim 11, wherein the curve-fitting comprises a polynomial fitting of a location of each object of interest over the multiple time frames to a polynomial having a plurality of coefficients, and wherein the one or more parameters are determined based on the plurality of coefficients of the polynomial.

13. The computing system of claim 10, wherein the machine-learned detector model is trained to generate one or more parameters descriptive of the motion of each detected object of interest for each point in the LIDAR data.

14. The computing system of claim 10, wherein the machine-learned detector model comprises a convolutional neural network.

15. An autonomous vehicle, comprising:
a sensor system comprising at least one sensor configured to generate multiple time frames of sensor data descriptive of an environment surrounding an autonomous vehicle;
a vehicle computing system comprising:
one or more processors; and
at least one tangible, non-transitory computer readable medium that stores instructions that, when executed by the one or more processors, cause the one or more processors to perform operations, the operations comprising:
inputting the multiple time frames of sensor data to a machine-learned detector model that is configured to implement curve-fitting of sensor data points over the multiple time frames of sensor data;
receiving, as an output of the machine-learned detector model, location information descriptive of a location of each object of interest detected within the environment at a given time and motion information descriptive of a motion of each object of interest; and
determining a motion plan for the autonomous vehicle that navigates the autonomous vehicle relative to each object of interest, wherein the motion plan is determined based at least in part from the location information and the motion information for each object of interest.

16. The autonomous vehicle of claim 15, wherein the motion information comprises one or more parameters, determined based on the curve-fitting, the parameters comprising one or more of a velocity and an acceleration of each object of interest.

17. The autonomous vehicle of claim 16, wherein the machine-learned detector model is configured to implement curve-fitting relative to each object of interest over the multiple time frames of sensor data to determine the parameters.

18. The autonomous vehicle of claim 16, wherein the curve-fitting comprises a polynomial fitting of a location of each object of interest over the multiple time frames to a polynomial having a plurality of coefficients, and wherein the one or more parameters are determined based on the plurality of coefficients of the polynomial.

19. The autonomous vehicle of claim 15, wherein the machine-learned detector model is configured to determine one or more parameters descriptive of the motion of each detected object of interest for each point in the sensor data.

20. The autonomous vehicle of claim 15, wherein the operations further comprise receiving, as an output of the machine-learned detector model, a classification for each object of interest and a bounding shape for each object of interest.
